(19) United States
(12) Patent Application Publication
(10) Pub. No.: US 2022/0347621 A1
(43) Pub. Date: Nov. 3, 2022

(54) SYSTEMS AND METHODS FOR REMOVING ODOR FROM A FLUID STREAM

(71) Applicant: PURAFIL, INC., Doraville, GA (US)

(72) Inventors: William G. England, Doraville, GA (US); Mei Xin, Suwanee, GA (US)

(73) Assignee: PURAFIL, INC., Doraville, GA (US)

(21) Appl. No.: 17/753,118

(22) PCT Filed: Aug. 12, 2020
(86) PCT No.: PCT/US20/70399

§ 371 Date: Feb. 18, 2022

Related U.S. Application Data
(60) Provisional application No. 62/890,259, filed on Aug. 22, 2019.

(51) Int. Cl. B01D 53/02; B01D 53/72; B01J 20/20; B01J 20/32

(52) U.S. Cl. CPC B01D 53/02; B01D 53/72; B01J 20/20; B01J 20/324; B01D 2251/50; B01D 2253/25; B01D 2253/304; B01D 2257/708; B01D 2258/06; B01D 2258/02

(57) ABSTRACT

A method for removing at least one odorous contaminant from a fluid stream by filtering the fluid stream with a filtration medium. The filtration medium includes a chemically modified activated carbon. The method is useful for removing one or more volatile organic compounds and/or one or more volatile thiol compounds, particularly terpenes (e.g., alpha-pinene and myrcene), nonanol, decanol, o-cymene, and benzaldehyde from the fluid stream. In some embodiments, the fluid stream is a cannabis grow house exhaust stream.

### TECHNICAL FIELD

The present invention relates generally to systems and methods for the removal of volatile organic compounds having disagreeable odors from gaseous streams and more particularly relates to the use of air filtration media in filter beds.

### BACKGROUND OF THE INVENTION

The processing of cannabis and production of cannabis products can result in odor emissions from cannabis grow houses. Although there have been no studies on health effects associated with exposure to cannabis odors in the scientific or grey literature, odors can result in annoyance and complaints from nearby residents. The strong odors produced are often described as pungent, skunky, floral, fruity, or even “sewer-like.”

The characteristic odor associated with cannabis is attributed to the release of chemical compounds into the air known as volatile organic compounds (VOCs). The major components of VOCs have been reported to consist of terpenes (limonene, alpha-pinene, myrcene, etc.). Specifically, due to high concentrations reported, myrcene has been used to gauge the odor emission. Over 200 different VOCs from packaged cannabis samples have been identified to date, including highly odorous compounds typically present in low concentrations, such as nonanol, decanol, o-cymene, and benzaldehyde, which have more potent odor impact than previously reported volatiles (e.g., terpenes). The structures of odorous compounds described herein are shown below:

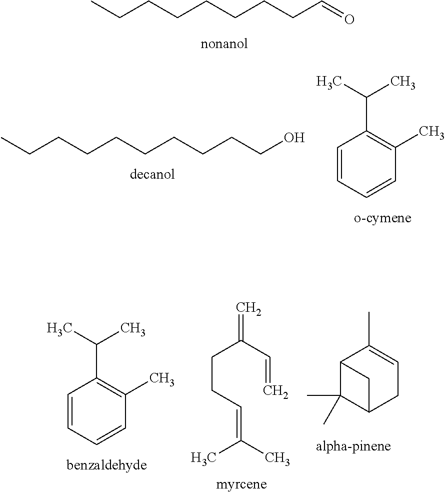

To better gauge the odor emission from cannabis grow houses, a unit of measure known as the odor unit (OAV, odor activity value), previously used in the food and beverage field, has been employed. The Ontario Ministry of Agriculture, Food and Rural Affairs uses the odor unit to categorize odors and to determine the compliance of industrial facilities with regulations under the Environmental Protection Act.

The odor unit is the ratio between the amount of odorant present in a volume of a neutral (odorless) gas at the odor detection threshold (OTD) of the odor evaluation panelists.

OAV=Concentration/OTD

When sampling for odorous compounds, compounds emitted at higher concentrations may not necessarily be responsible for the overall characteristic of the odor. Additionally, the overall odor of cannabis can be time dependent as VOCs volatilization occur at different rates. And, in addition to VOCs, volatile thiols such as 2-butene-1 thiol and 3-methyl-1-butanethiol may contribute to pungent odors. Both have extremely low odor detection thresholds. Cannabis contains alpha-linolenic acid, which may break down under the ultraviolet rays of sunlight into methyl and butyl thiols.

Carbon filters, also known as carbon scrubbers, are standard odor-control devices in grow rooms, such as grow rooms used for the cultivation of cannabis plants. Carbon filters use activated carbon, which adsorbs impurities and aromas from the air through a physical adsorption, trapping them inside the pore structure of the carbon substrate. However, carbon filters have been criticized as odor complaints continue to be filed with local governments even after carbon filters have been employed in an attempt to reduce grow house odors. Adsorption performance is highly affected by humidity, and the higher humidity present in grow houses is believed to lower adsorption of the odor-causing substances. Furthermore, the use of activated carbon in grow houses has promoted microbial and bacterial growth due to the high humidity and high temperatures employed, resulting in crop contamination and low yield.

Activated carbon includes a wide range of amorphous carbon-based materials prepared by combustion, partial combustion, and thermal decomposition of various carbonaceous substances. These materials may be granular, cylindrical, or in powdered form.

Activated carbons are the most widely used adsorbent for capturing volatile organic contaminants (VOCs) from gaseous streams. The adsorbent properties of activated carbons are essentially attributed to their large surface area and high pore volume with a suitable pore size distribution, which makes the internal surface accessible, and enhances the adsorption rate.

Activated carbon adsorbs VOCs from the air mainly through a physical process, and traps them inside the adsorption pores. The adsorbed material is adsorbed rather loosely, and can easily be released (desorbed).

Additionally, water vapor is often present at high levels in gas stream feeds and humidity has a noticeable effect on carbon VOC adsorption. Capillary condensation of water may happen on activated carbon. Typically, water adsorption occurs where oxygen complexes form on the activated carbon, providing a hydrophilic site favorable to water adsorption due to hydrogen bonding. The adsorbed water attracts more water, and water aggregates grow on the activated carbon.

The adsorbed water can decrease the available surface for adsorption and may reduce the rate of diffusional mass transport. Research has shown that a carbon surface saturated with water is not accessible to soluble organic vapors. Further, cooperative adsorption can take place between hydrophilic VOCs (e.g., ethanol) and water vapor up to certain humidity levels, but above these levels competitive adsorption has a deleterious effect.

Therefore, what is needed is an air filtration media having improved VOC adsorption and resistance to bacteria and/or mold growth for reducing odors in and released from cannabis grow houses.

### SUMMARY OF THE INVENTION

Described herein are methods of removing an odor from a cannabis grow house exhaust stream, comprising: providing a first compound comprising activated carbon; providing a second compound comprising a surfactant; doping the first compound with the second compound to provide a chemically modified compound; placing the chemically modified compound the cannabis grow house exhaust stream; and reacting odorous compounds in the cannabis grow house exhaust with the chemically modified compound. In some examples, providing activated carbon comprises providing activated carbon powder and activated carbon pellets. In certain aspects, providing the surfactant comprises providing sulfamic acid (e.g., providing a sulfamic acid powder or providing a sulfamic acid liquid solution). In certain examples, doping the first compound with the second compound to provide a chemically modified compound comprises spraying the sulfamic acid liquid solution onto the activated carbon, or dissolving the sulfamic acid powder in a solvent to provide a sulfamic acid solution and spraying the sulfamic acid solution onto the activated carbon.

In certain cases, placing the chemically modified compound in the cannabis grow house exhaust stream comprises placing the chemically modified compound into a housing, and positioning the housing in an exhaust system of the cannabis grow house. Thus, in some examples, reacting the odorous compounds in the cannabis grow house exhaust with the chemically modified compound comprises reacting volatile organic compounds and volatile thiol compounds with chemically modified activated carbon. For example, reacting volatile organic compounds with chemically modified activated carbon comprises cleaving double bonds inherent to volatile organic compounds and catalyzing a hydration reaction to provide water-soluble volatile organic compounds. Additionally, reacting volatile thiol compounds with chemically modified activated carbon comprises oxidizing the volatile thiol compounds and forming non-odorous sulfonic acid.

Also described herein are systems for removing an odorous contaminant from a cannabis grow house exhaust stream, comprising: a chemically modified activated carbon, wherein the chemically modified activated carbon comprises activated carbon doped with an impregnate; and a housing configured to position the chemically modified activated carbon in the cannabis grow house exhaust stream. In some examples, odors are reduced by removing a volatile organic compound, combination of volatile organic compounds, a volatile thiol compound, a combination of volatile thiol compounds, or any combination thereof from the cannabis grow house exhaust stream. In some cases, the odorous compound removed is nonanol, decanol, o-cymene, benzaldehyde, myrcene or alpha-pinene. As described herein, the chemically modified activated carbon includes from about 0.1% to about 25% by weight of impregnate. In some examples, the impregnate contains from about 0.1% to about 10% by weight surfactant (e.g., sulfamic acid). In certain aspects, the housing contains the chemically modified activated carbon and is configured to position the chemically modified activated carbon in the cannabis grow house exhaust stream (i.e., the housing directs the grow house exhaust stream across the chemically modified activated carbon).

Further described herein is a method of producing a chemically modified activated carbon for use in grow houses, comprising: providing an activated carbon; doping the activated carbon with an impregnate to provide an impregnated activated carbon; and drying the impregnated activated carbon to provide the chemically modified activated carbon. In some examples, the impregnate is applied to the activated carbon in a form of a liquid solution. In some cases, the impregnate is sprayed onto the activated carbon. In certain aspects, drying the impregnated activated carbon is achieved by removing residual solvent from the impregnated activated carbon.

### BRIEF DESCRIPTION OF THE FIGURES

FIG. 1 is a graph showing alpha-pinene adsorption by a comparative activated carbon and the chemically modified activated carbon according to certain embodiments described herein.

FIG. 2 is a graph showing alpha-pinene adsorption by a comparative activated carbon and the chemically modified activated carbon according to certain embodiments described herein.

### DETAILED DESCRIPTION OF THE INVENTION

A chemically modified activated carbon filtration media and methods of treating a fluid stream with the media are provided. The chemically modified activated carbon filtration media can be used to remove or reduce undesirable odor-causing compounds from a gaseous fluid stream released or escaping from a cannabis grow house, for example, a cannabis grow house exhaust stream. The cannabis grow house exhaust stream can include any gases (e.g., air, carbon dioxide, and the like) flowing through a suitable vent, port, or passage, allowing the gases to exit the cannabis grow house. The chemically modified activated carbon filtration media is chemically modified with an impregnate, which is a surfactant. The impregnate preferably, but does not have to be, applied to the air filtration media as a liquid impregnate solution.

Terms such as “filtration media”, “adsorbent composition,” “chemisorbent composition,” and “impregnated substrate” are all interchangeable, and denote a substance that is capable of reducing or eliminating the presence of unwanted contaminants in fluid streams by the contact of such a substance with the fluid stream. It is to be understood that the term “fluid” is defined as a liquid or gas capable of flowing, or moving in a particular direction, and includes gaseous, aqueous, organic containing, and inorganic containing fluids.

Generally described, the chemically modified activated carbon filtration media is chemically modified with a solution containing a surfactant. A preferred surfactant is sulfamic acid. In general, chemical modification can include doping a first compound with a second compound, wherein the second compound is either physically or chemically admixed with the first compound to alter the properties of the first compound. As described herein, the first compound is activated carbon (e.g., activated carbon powder and/or activated carbon pellets), and the second compound is an impregnate, wherein the impregnate can include a solvent and a dopant (e.g., the second compound). As described herein, after doping the chemically modified activated carbon can include from about 0.1% to about 25% by weight of the impregnate. For example, the chemically modified activated carbon can include from about 0.5% to about 20%, from about 0.75% to about 20%, from about 0.8% to about 15%, from about 0.9% to about 10%, from about 1% to about 7.5%, or from about 2% to about 5% by weight of the impregnate. In some cases, the impregnate can include the from about 0.1% to about 10% by weight surfactant (e.g., sulfamic acid). For example, the impregnate can include from about 0.25% to about 9%, from about 0.5% to about 8%, from about 0.75% to about 7%, from about 1% to about 6%, from about 2% to about 5%, or from about 3% to about 4% by weight surfactant.

The activated carbon can be provided as a powder, as a granule, or as a pellet. In certain aspects, the powder and/or the granule can be formed into a pellet. Activated carbon can have a particle size of from about 4 mesh to about 2500 mesh (e.g., from about 6 mesh to about 1250 mesh, from about 8 mesh to about 625 mesh, from about 12 mesh to about 400 mesh, or anywhere in between). In some cases, the activated carbon is provided having a polydispersed size range. For example, the activated carbon can have a mesh size of 20×50, wherein the largest screen mesh size the activated carbon particles can pass through is a 20 mesh, and the smallest screen mesh size the activated carbon particles can pass through is a 50 mesh.

When applied to the activated carbon, the surfactant allows the chemically modified activated carbon to remove or reduce undesirable compounds, or contaminants, from a gaseous fluid stream. In particular, the chemically modified activated carbon can cleave double bonds inherent to volatile organic compounds (VOCs), or a combination of undesirable volatile organic compounds, particularly, but not limited to, nonanol, decanol, o-cymene, benzaldehyde, myrcene, alpha-pinene, and/or any combination thereof. Alpha-pinene, as used herein, is a monoterpenoid compound. It contains C10 with a single C═C double bond and bicyclo[2.2.1] heptane.

In some cases, the contaminant includes volatile thiol compounds, combinations of volatile thiol compounds, and/or combinations of VOCs and volatile thiol compounds. For example, a volatile thiol compound can be butyl thiols (e.g., 2-butene-1 thiol) and/or methyl thiols (e.g., 3-methyl-1-butanethiol). The chemically modified activated carbon can filter additional odorous contaminants, including aldehydes, alcohols, and terpenes (limonene, alpha-pinene, myrcene, or the like).

In some cases, the chemically modified activated carbon can catalyze a hydration reaction, making the VOCs more water soluble. In certain aspects, the chemically modified activated carbon can function at various humidity levels (e.g., from about 25% relative humidity (RH) up to 100% RH). For example, the chemically modified activated carbon can function at about 25% RH, about 26% RH, about 27% RH, about 28% RH, about 29% RH, about 30% RH, about 31% RH, about 32% RH, about 33% RH, about 34% RH, about 35% RH, about 36% RH, about 37% RH, about 38% RH, about 39% RH, about 40% RH, about 41% RH, about 42% RH, about 43% RH, about 44% RH, about 45% RH, about 46% RH, about 47% RH, about 48% RH, about 49% RH, about 50% RH, about 51% RH, about 52% RH, about 53% RH, about 54% RH, about 55% RH, about 56% RH, about 57% RH, about 58% RH, about 59% RH, about 60% RH, about 61% RH, about 62% RH, about 63% RH, about 64% RH, about 65% RH, about 66% RH, about 67% RH, about 68% RH, about 69% RH, about 70% RH, about 71% RH, about 72% RH, about 73% RH, about 74% RH, about 75% RH, about 76% RH, about 77% RH, about 78% RH, about 79% RH, about 80% RH, about 81% RH, about 82% RH, about 83% RH, about 84% RH, about 85% RH, about 86% RH, about 87% RH, about 88% RH, about 89% RH, about 90% RH, about 91% RH, about 92% RH, about 93% RH, about 94% RH, about 95% RH, about 96% RH, about 97% RH, about 98% RH, about 99% RH, or about 100% RH. In some cases, the chemically modified activated carbon minimizes competitive adsorption between the VOCs and water at all humidity levels, thus ensuring the VOCs are adsorbed onto the chemically modified activated carbon instead of water.

As discussed above, the impregnate could be, but does not have to be, applied to the activated carbon as a liquid impregnate solution. The liquid solution could be sprayed onto the activated carbon or could be applied by other known methods. In certain examples, after the liquid solution is applied to the activated carbon providing the impregnated activated carbon, the impregnated activated carbon is dried to provide the chemically modified activated carbon. Drying includes removing residual solvent from the impregnated activated carbon (e.g., removing water, organic solvents, inorganic solvents, any suitable solvent used to provide the impregnate in a liquid solution, or any combination thereof). In certain cases, drying can be performed in a drying oven, in a kiln, under vacuum, under an air flow, under an inert gas flow, by any suitable drying means, or any combination thereof.

Alternatively, the impregnate could be provided as a powder. The powder could be applied directly to the activated carbon, or water or another liquid could be added to the powder to hydrate it prior to application of the impregnate composition onto the activated carbon.

Specific methods of applying liquid or powder impregnate compositions onto air filtration media are known and are not important to the invention described herein.

In certain examples, the chemically modified activated carbon is placed into a housing that is placed in the cannabis grow house exhaust stream to be filtered. The housing can be of any shape to conform to a flow path of the cannabis grow house exhaust stream. For example, the housing can be a square or rectangle shape when used in rectangular duct work. In some cases, the housing can be a circle or elliptical shape when used in round duct work. The housing, as described herein, is a vehicle to place the chemically modified activated carbon into the flow path of the cannabis grow house exhaust stream to be filtered. In some examples, the housing includes at least a first screen, mesh, fiber weave, or the like, to allow the cannabis grow house exhaust stream to flow through the housing and maintain the chemically modified activated carbon within the housing. Optionally, the housing includes at least a second screen, mesh, fiber weave, or the like, such that the chemically modified activated carbon is positioned between the first screen and at least the second screen. Thus, the housing can be configured to direct the cannabis grow house exhaust stream over the chemically modified activated carbon when the cannabis grow house exhaust stream flows through the first screen entering the housing, over the chemically modified activated carbon, and through the second screen exiting the housing.

Specific methods of housing particulate filtration media, for example, activated carbon and/or chemically modified activated carbon, are known and are not important to the invention described herein.

### Contaminant Removal Methods

Also provided is a method of treating a contaminated fluid stream, such as a fluid stream escaping from or released from a cannabis grow house, using the chemically modified activated carbon described herein. This method involves contacting the contaminated cannabis grow house exhaust stream with the chemically modified activated carbon provided herein. Typically, the undesired contaminants will be removed from air, especially from air admixed with effluent gas streams resulting from odorous plant production. A liquid or powder impregnate could be sold to a consumer for manual application to an activated carbon filter by the consumer. Methods of treating gaseous or other fluid streams are well known in the art. Any method known in the art of treating fluid streams with the chemically modified activated carbon described herein may be used.

Not to be bound by theory, the chemically modified activated carbon described herein provides an enhanced odor adsorption when compared to activated carbon devoid of the chemical modification (i.e., comparative activated carbon). In certain examples, the chemically modified activated carbon described herein including the surfactant (e.g., sulfamic acid) increases volatile thiol compound adsorption by completely oxidizing the volatile thiol compounds and forming non-odorous sulfonic acid. Further, comparative activated carbon cannot completely oxidize volatile thiol compounds, producing odorous disulfide compounds. Thus, the comparative activated carbon cannot completely remove odorous compounds from a cannabis grow house exhaust stream. Further, disulfide compounds can further revert to a mercaptan compound, a common odorant, further illustrating the inability of the comparative activated carbon to completely remove odorous compounds from a cannabis grow house exhaust stream.

Additionally, the chemically modified activated carbon described herein inhibits microbial and/or bacterial growth. In certain aspects, the surfactant (e.g., the sulfamic acid) can create a harsh environment where microbial and/or bacterial growth cannot occur. Conversely, the comparative activated carbon can allow and/or promote microbial and bacterial growth when used in environments having high RH values and/or high temperatures. Thus, the chemically modified activated carbon described herein is amenable to use in high RH environments and exhibits a longer service lifetime than the comparative activated carbon.

The chemically modified activated carbon described herein can remove a plurality of odorous compounds from a cannabis grow house exhaust stream, for example, aldehyde compounds, alcohol compounds, thiol compounds, terpene compounds, and the like. Further, the chemically modified activated carbon described herein is resistive to mold, mildew, fungal, microbial, and bacterial growth common in environments having elevated RH values and/or elevated temperatures. Thus, the chemically modified activated carbon described herein does not exhibit reduced filtration at high RH values.

Some exemplary embodiments of the present invention will now be illustrated in the following specific, non-limiting example.

### Example

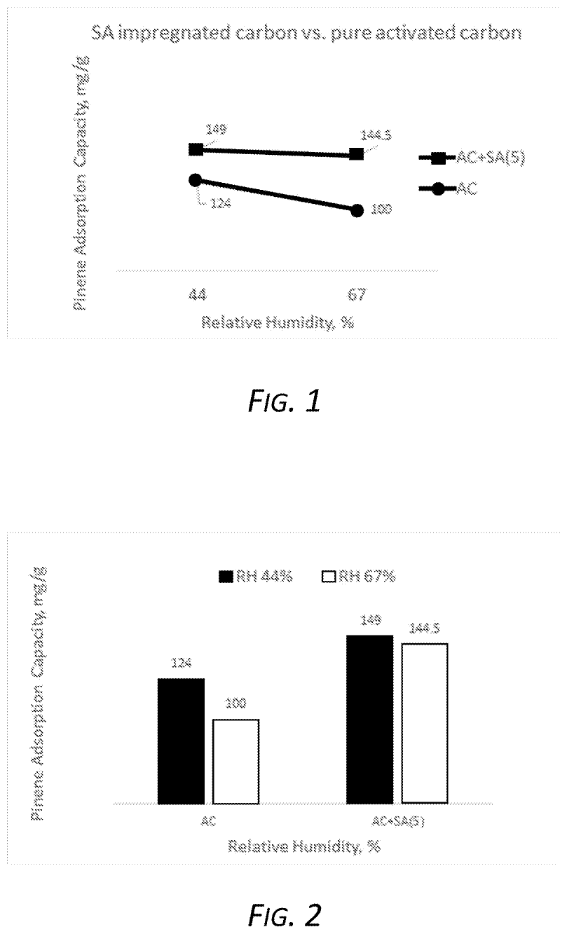

Coconut-based activated carbon was impregnated with a surfactant solution containing 5% sulfamic acid (referred to as “SA(5)” in the example of FIG. 1). Then, 20 mg of 20×50 mesh activated carbon was placed in a glass test tube having a diameter of 5 mm supported by glass wool. An air stream containing 18 ppm (33.3 mg/m³) alpha-pinene was flowed through the chemically modified activated carbon at a rate of 0.9 L/minute and alpha-pinene outlet concentration was continuously monitored by a Honeywell MiniRae™ photoionization detector (PID). Before and after each measurement, a baseline alpha-pinene concentration was recorded to ensure the system was free of contamination and did not leak. The test was performed under 44% RH and 67% RH.

FIGS. 1 and 2 show that chemical modification, as described herein, significantly improved the activated carbon adsorption of alpha-pinene when compared to activated carbon that was not chemically modified (i.e., the comparative activated carbon, referred to as “AC” in the example of FIGS. 1 and 2). The chemically modified activated carbon (referred to as “AC+SA(5)” in the example of FIGS. 1 and 2) adsorbed from 20% to 45% more alpha-pinene at both low (44%) and high (67%) RH conditions, respectively. Thus, the chemically modified activated carbon exhibited improved alpha-pinene adsorption regardless of humidity.

It should be understood, of course, that the foregoing relates only to certain embodiments of the present invention and that numerous modifications or alterations may be made therein without departing from the spirit and the scope of the invention. All of the publications or patents mentioned herein are hereby incorporated by reference in their entireties.

1. A method of removing an odor from a cannabis grow house exhaust stream, comprising:
providing a first compound comprising activated carbon;
providing a second compound comprising a surfactant;
doping the first compound with the second compound to provide a chemically modified compound;
placing the chemically modified compound in the cannabis grow house exhaust stream; and
reacting odorous compounds in the cannabis grow house exhaust with the chemically modified compound.

2. The method of claim 1, wherein the activated carbon comprises activated carbon powder or activated carbon pellets.

3. The method of claim 1, wherein the surfactant comprises sulfamic acid.

4. The method of claim 3, wherein the sulfamic acid comprises a sulfamic acid powder or a sulfamic acid liquid solution.

5. The method of claim 4, wherein the sulfamic acid comprises the sulfamic acid liquid solution and wherein doping comprises spraying the sulfamic acid liquid solution onto the activated carbon.

6. The method of claim 4, wherein the sulfamic acid comprises the sulfamic acid powder and wherein doping comprises dissolving a the sulfamic acid powder in a solvent to provide a sulfamic acid solution and spraying the sulfamic acid solution onto the activated carbon.

7. The method of claim 1, wherein placing the chemically modified compound in the cannabis grow house exhaust stream comprises placing the chemically modified compound into a housing, and positioning the housing in an exhaust system of the cannabis grow house.

8. The method of claim 1, wherein reacting the odorous compounds in the cannabis grow house exhaust with the chemically modified compound comprises reacting volatile organic compounds and volatile thiol compounds with chemically modified activated carbon.

9. (canceled)

10. (canceled)

11. A system for removing an odorous contaminant from a cannabis grow house exhaust stream, comprising:
a chemically modified activated carbon, wherein the chemically modified activated carbon comprises activated carbon doped with an impregnate; and
a housing configured to position the chemically modified activated carbon in the cannabis grow house exhaust stream.

12. The system of claim 11, wherein the odorous contaminant comprises a volatile organic compound, combination of volatile organic compounds, a volatile thiol compound, a combination of volatile thiol compounds, or any combination thereof.

13. The system of claim 11, wherein the odorous contaminant comprises nonanol, decanol, o-cymene, benzaldehyde, myrcene, and alpha-pinene.

14. The system of claim 11, wherein the chemically modified activated carbon comprises from about 0.1% to about 25% by weight of the impregnate.

15. The system of claim 11, wherein the impregnate comprises from about 0.1% to about 10% by weight of a surfactant.

16. The system of claim 11, wherein the surfactant comprises sulfamic acid.

17. The system of claim 11, wherein the housing contains the chemically modified activated carbon.

18. The system of claim 17, wherein the housing directs the cannabis grow house exhaust stream across the chemically modified activated carbon.

19. A method of producing a chemically modified activated carbon, comprising:
providing an activated carbon;
doping the activated carbon with an impregnate to provide an impregnated activated carbon; and
drying the impregnated activated carbon to provide the chemically modified activated carbon.

20. The method of claim 19, wherein doping the activated carbon comprises applying a liquid solution of the impregnate to the activated carbon.

21. The method of claim 19, wherein doping the activated carbon comprises spraying the impregnate onto the activated carbon.

22. The method of claim 19, wherein drying the impregnated activated carbon comprises removing a residual solvent from the impregnated activated carbon.
